(19) United States
(12) Patent Application Publication
(10) Pub. No.: US 2003/0068548 A1
(43) Pub. Date: Apr. 10, 2003

(54) Square top

(76) Inventor: Donald J. E. Miller JR., Tampa, FL (US)

Correspondence Address: Donald J. E. Miller, Jr., 6509 Secrest Ct, Tampa, FL, 33625, US

(21) Appl. No.: 09/972,625

(22) Filed: Oct. 9, 2001

(51) Int. Cl. H01M 2/04

(52) U.S. Cl. 429/175; 429/164; 429/185

(57) ABSTRACT

Square top is a battery octoangular in shape and longer than some batteries, with a tip longer than some batteries. With a shape that stops it from rolling.

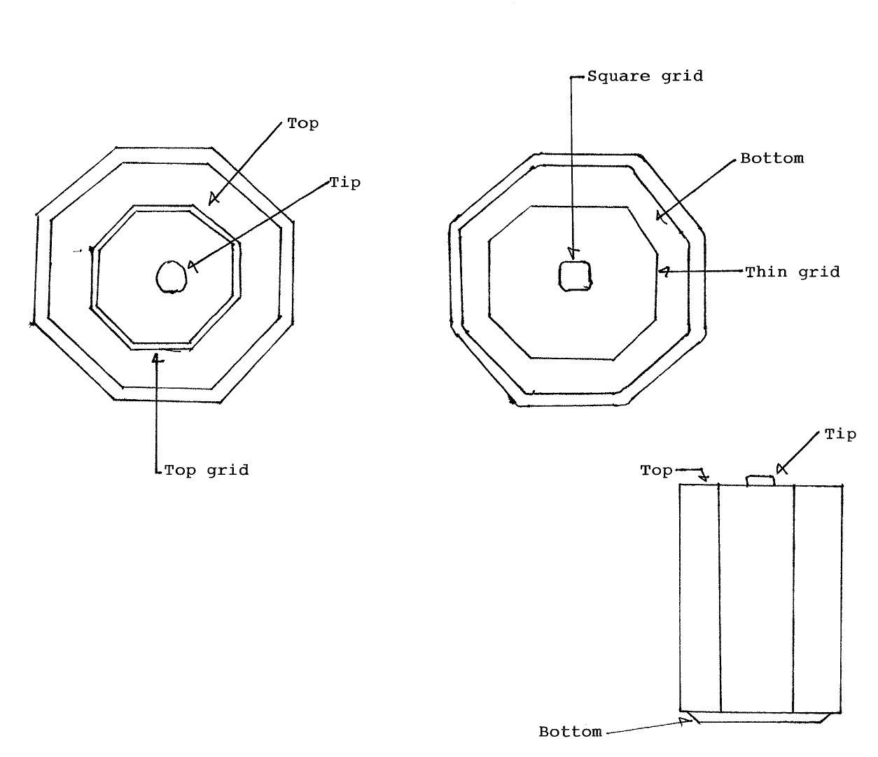

### SPECIFICATION

The square top is a battery like any other battery except, the square top is octoangular shaped and in comes in varies sizes. The square top will have a tip longer than some of the batteries on the market. The shape of the batteries are helpful in as much as it will not roll when it is pored out of a flash light or rolling around in a drawer. Square top can be stacked on top of each other side by side, and because of the longer tip it can power items that some batteries can't.

### BACKGROUND

1. Field

This invention relates to batteries.

2. Information

The square top is a battery that is made a little longer than some batteries and octoangular shaped. The longer tip on the square top will help run items such as flashlights with dividers in them; these dividers keep other small tip batteries from making any connection. The shape of the batteries keep it from rolling away when you lay it down, and they can be stacked to consolidate space.

### SUMMARY

The square top can be used like other batteries, and comes in sizes like D, C, AA and AAA. Unlike other batteries the square top will not roll off the table when it's laid down, and can be simply staged away.

### DESCRIPTION OF DRAWINGS

1. Shows different views of Square top.

### DESCRIPTION OF INVENTION

The square top is octoangular shaped and is approximately 2⅜″ long from the top of the battery tip to the bottom of the battery and 1¼″ wide from corner to corner and 4¼″ around. The tip on the batteries are approximately ⅛″ long, and the bottom of the battery protrudes from the body slightly. There are two octoangular grids, one will be an outward grid approximately ⅛″ wide on top of the battery and a thin inward grid on the bottom, plus a thin smaller inward square grid in the bottom center of the battery.

1. I claim Square Top, as described herein specifications and in the drawings, a battery octoangular in shape and deferent sizes like D, C, AA and AAA etc.
